(19) United States
(12) Patent Application Publication
(10) Pub. No.: US 2004/0120644 A1
(43) Pub. Date: Jun. 24, 2004

(54) Method of making subwavelength resonant grating filter

(76) Inventors: Stephen Y. Chou, Princeton, NJ (US); Allan S.P. Chang, Princeton, NJ (US); Hua Tan, Plainsboro, NJ (US); Jim Jian Wang, Orefield, PA (US); Wei Wu, Mountain View, CA (US); Rich Zhaoning Yu, Levittown, PA (US)

Correspondence Address: GLEN E. BOOKS, ESQ., LOWENSTEIN SANDLER PC, 65 LIVINGSTON AVENUE, ROSELAND, NJ, 07068, US

(21) Appl. No.: 10/674,607

(22) Filed: Sep. 30, 2003

Related U.S. Application Data
(63) Continuation-in-part of application No. 10/244,276, filed on Sep. 16, 2002.
Application No. 10/244,276 is a continuation of application No. 10/046,594, filed on Oct. 29, 2001.
Application No. 10/244,276 is a continuation-in-part of application No. 10/140,140, filed on May 7, 2002.
Application No. 10/140,140 is a division of application No. 09/618,174, filed on Jul. 18, 2000, now Pat. No. 6,482,742.
(60) Provisional application No. 60/415,048, filed on Sep. 30, 2002.

(51) Int. Cl. G02B 6/34

(52) U.S. Cl. 385/37; 385/129

(57) ABSTRACT

In accordance with the invention, a SRG filter is fabricated by disposing a moldable layer on the unpatterned grating layer, pressing a patterned molding surface into the moldable layer to produce an appropriate pattern of reduced thickness regions, removing material from the reduced thickness regions to expose the grating layer and processing the exposed grating layer to form a grating array. In a preferred embodiment the grating layer is adjacent a planar waveguiding layer overlying a substrate and the moldable material is a polymer resist. The waveguide layer advantageously has a refractive index greater than both the grating layer and the underlying substrate. And the pattern can be a one or two-dimensional array of grating elements.

### CROSS REFERENCE TO RELATED APPLICATIONS

The application claims the benefit of U.S. Provisional Patent Application Serial No. 60/415,048 filed by Stephen Y. Chou et al. on Sep. 30, 2002 and entitled “Optical Filters With Fixed and Tunable Frequency,” which is incorporated herein by reference.

This application is a continuation-in-part of U.S. patent application Ser. No. 10/244,276 filed by Stephen Chou on Sep. 16, 2002 and entitled “Lithographic Method For Molding Pattern With Nanoscale Features” which, in turn, is a continuation of U.S. application Ser. No. 10/046,594 filed by Stephen Chou on Oct. 29, 2001, which claims priority to U.S. patent application Ser. No. 09/107,006 filed by Stephen Chou on Jun. 30, 1998 (now U.S. Pat. No. 6,309,580 issued Oct. 30, 2001) and which, in turn, claims priority to U.S. application Ser. No. 08/558,809 filed by Stephen Chou on Nov. 15, 1995 (now U.S. Pat. No. 5,772,905 issued Jun. 30, 1998). All of the foregoing Related Applications are incorporated herein by reference.

This application is also a continuation-in-part of U.S. patent application Ser. No. 10/140,140 filed by Stephen Chou on May 7, 2002 and entitled “Fluid Pressure Imprint Lithography” which, in turn, is a Divisional of U.S. patent application Ser. No. 09/618,174 filed by Stephen Chou on Jul. 18, 2000 and entitled “Fluid Pressure Imprint Lithography” (now U.S. Pat. No. 6,482,742 issued Nov. 19, 2002).

### GOVERNMENT INTEREST

This invention was made with government support under DARPA contracts 341-6086 and 341-4131. The government has certain rights to this invention.

### FIELD OF THE INVENTION

This invention relates to optical filters and, in particular, to a method of making subwavelength resonant grating filters.

### BACKGROUND OF THE INVENTION

Optical filters are key components in a wide variety of optical systems including optical telecommunications, optical displays and optical data storage. An optical filter is used to selectively reflect or transmit light of a predetermined wavelength. Typical uses include channel selection in wavelength division multiplexed (WDM) systems, multiplexers, and demultiplexers, switches and wavelength selective laser cavity reflectors.

Subwavelength resonant grating filters (SRGFs) are highly promising for many filter applications. Such filters typically comprise a linear array of grating lines overlying an optical waveguide and appropriate cladding. The spacing between successive grating lines is smaller than the wavelength of the light they process, hence they are called subwavelength gratings. They are highly reflective for light of a specific wavelength that resonates with the spaced grating lines. Further details concerning such filters can be found, for example, in U.S. Pat. No. 5,216,680 issued to Magnusson et al. on Jan. 1, 1993 and U.S. Pat. No. 5,598,300 issued to Magnusson et al. on Jan. 28, 1997, which patents are incorporated herein by reference.

While the foregoing Magnusson et al. patents provide extensive theoretical discussion of the desirable features and dimensions of SRGFs, they provide little guidance as to how such precise structures can be quickly and economically fabricated with nanoscale features. Presumably Magnusson et al. contemplate fabrication by conventional thin film photolithographic techniques. But photophotolithography of nanoscale features requires huge investment in equipment and complex multistep processing.

In addition, conventional SRGFs employing linear arrays of grating lines are unfortunately polarization dependent. The gratings are one dimensional arrays, and, for polarized light, their reflection characteristics depend on the orientation of light polarization in relation to the direction of the array. Since the polarization of light in many applications can vary, the polarization dependence of conventional one dimensional subwavelength resonant filters presents an unwanted variable that cannot be easily controlled.

An advantageous approach for eliminating polarization dependence in SRGFs is to form the grating as a two dimensional array of nanoscale holes. See S. Peng, “Experimental demonstration of resonant anomalies in diffraction from two-dimensional gratings,” Optics Letters, Vol. 21, No. 8, p. 549 (Apr. 15, 1996). Making such gratings using photolithographic techniques however requires multiple holographic exposures and is substantially more complex than making linear arrays. Accordingly there is a need for an improved process for making subwavelength resonant grating filters.

### SUMMARY OF THE INVENTION

In accordance with the invention, a SRG filter is fabricated by disposing a moldable layer on the unpatterned grating layer, pressing a patterned molding surface into the moldable layer to produce an appropriate pattern of reduced thickness regions, removing material from the reduced thickness regions to expose the grating layer and processing the exposed grating layer to form a grating array. In a preferred embodiment the grating layer is adjacent a planar waveguiding layer overlying a substrate and the moldable material is a polymer resist. The waveguide layer advantageously has a refractive index greater than both the grating layer and the underlying substrate. And the pattern can be a one or two-dimensional array of grating elements.

### BRIEF DESCRIPTION OF THE DRAWINGS

The nature, advantages and various additional features of the invention will appear more fully upon consideration of the illustrative embodiments now to be described in detail in connection with the accompanying drawings. In the drawings:

FIG. 1 is a schematic illustration of an exemplary subwavelength resonant grating filter fabricated in accordance with the invention;

FIG. 2 is a transmission spectrum of a typical FIG. 1 filter;

FIG. 3 is a flow diagram of the steps involved in fabricating the FIG. 1 filter; and

FIGS. 4A-4D are schematic cross sections of a typical filter workpiece at various stages in the fabrication process of FIG. 3.

It is to be understood that these drawings are for purposes of illustrating the concepts of the invention and, except for the graph, are not to scale.

### DETAILED DESCRIPTION

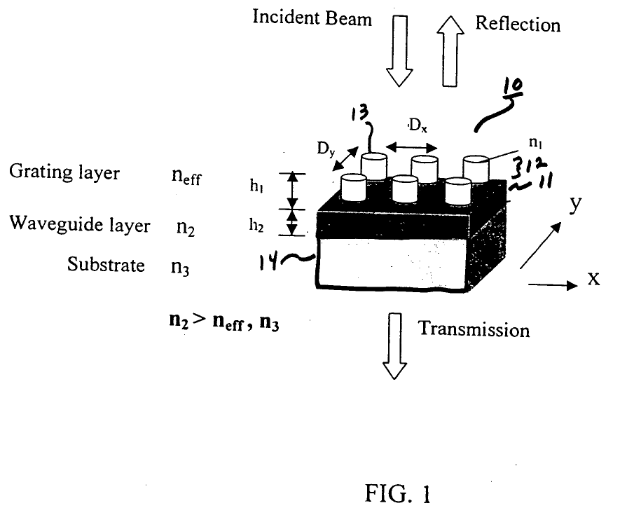

Referring to the drawings, FIG. 1 is a schematic illustration of a subwavelength resonant grating filter 10 fabricated in accordance with the invention. In essence the filter 10 comprises a waveguide layer 11 and a grating layer 12 adjacent the waveguide layer and optically coupled thereto. The grating layer is patterned into a two-dimensional array of nanoscale diffraction elements 13. The array of elements 13 forms a two-dimensional grating structure that is periodic in two orthogonal directions (x,y). It has a period Dₓ in the x-direction less than a wavelength of the light to be processed and a period D_{y} in the y-direction also less than a wavelength. The subwavelength periods Dₓ and D_{y} are preferably but not necessarily equal. The waveguide layer 11 can be conveniently formed overlying an optional substrate layer 14.

Each of the layers 11, 12, 14 advantageously comprises a transparent dielectric material. The waveguide layer index of refraction, n₂, should be greater than the grating layer effective index, n_{eff}, and greater than the substrate index, n₃.

The diffraction elements 13 (also referred to as grating elements) are advantageously circular pillars of nanoscale diameter, but could alternatively be nanoscale elements of other shape such as rectangular pillars, pyramids, cones or even holes, so long as the array exhibits subwavelength periodicity in two orthogonal directions. Typically the elements are 20-200 nanometers in height. Their maximum lateral dimension is typically in the range 100-600 nanometers. Typical periodic spacings are in the range 200 nanometers to 1.2 micrometers.

In an exemplary device for light of 1.55 micrometer wavelength, the substrate can be glass, the waveguide layer SiO₂ and the grating layer composed of nanoscale diameter pillars of silicon nitride. Pillar diameter was 500 nanometers, pillar height 100 nanometers and periodic spacing, one micrometer. Alternatively, the device can be implemented in semiconductor materials such as InGaAsP/InP.

In operation, light is shone onto the filter 10, typically at normal incidence to the plane of the grating layer. Since the grating elements are arrayed with subwavelength spacing, the light will experience the grating layer as an effectively homogenous layer with an effective index n_{eff}, and, except for light at a certain resonant wavelength λₒ, the light will transmit through the device as if it were a thin-film structure.

For light at the resonant wavelength λₒ, the diffraction from the grating elements produces an evanescent wave along the x-y plane. The evanescent wave couples with a waveguide mode supported by the waveguide layer, propagating a waveguide mode within the waveguide layer. Due to the phase matching of the grating elements, the waveguide mode radiates energy transverse to the waveguide layer at a phase that interferes constructively with the reflection and destructively with the transmission. The result is that substantially all energy at λₒ is reflected and substantially no energy λₒ is transmitted.

An important advantage of this particular device is its polarization-independence. In conventional gratings with one-dimensional grating periodicity, only one polarization component of the light can be coupled into the waveguide at a resonant wavelength λₒ. This is due to the difference between the TE and TM modes in the waveguide. Thus conventional filters are polarization dependent and transmit some of the light at λₒ.

With the two-dimensional grating filters described herein, both polarization components can be coupled into two orthogonal directions due to the symmetry of the grating. Therefore the filters are polarization independent and substantially all light at λₒ is reflected.

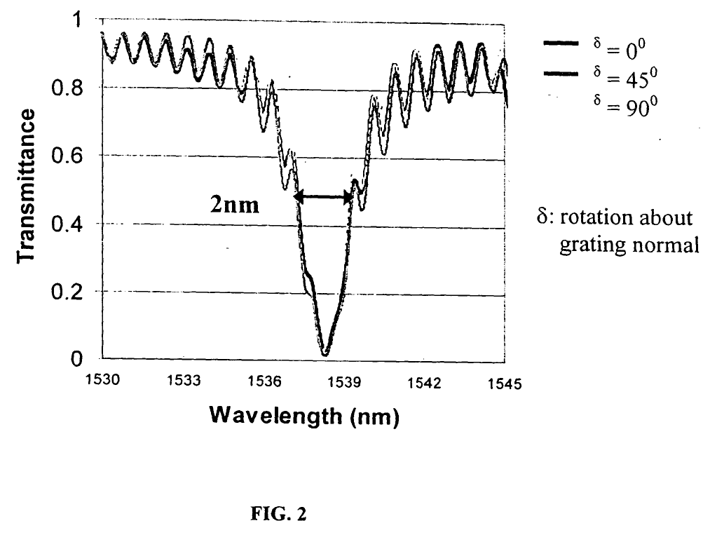

FIG. 2 graphically illustrates this polarization independence of the FIG. 1 filter. The figure graphically plots measured transmittance versus wavelength curves for three polarization states separated by increments of 45° around the grating normal. As can be seen, the curves are substantially coincident for all three states.

In designing such a filter for a particular application, the location of the resonant wavelength is determined primarily by the value of the grating period. In general,

λₒ=aD+b,

where λₒ is the resonant wavelength, D is the grating period and a, b are constants.

The bandwidth of the filter is determined primarily by the thickness hₗ (FIG. 1) of the grating layer. In general, the Full-Width-Half-Maximum (FWHM) of the filter follows a quadratic relationship of the grating thickness. It is thus possible to obtain a very narrowband filter by using a very thin grating layer. For example, a sub-nanometer FWHM can be obtained with grating thickness less than 60 nanometers. For use with light incidence other than normal, polarization-independence is achieved by grating periods that are different in two orthogonal directions.

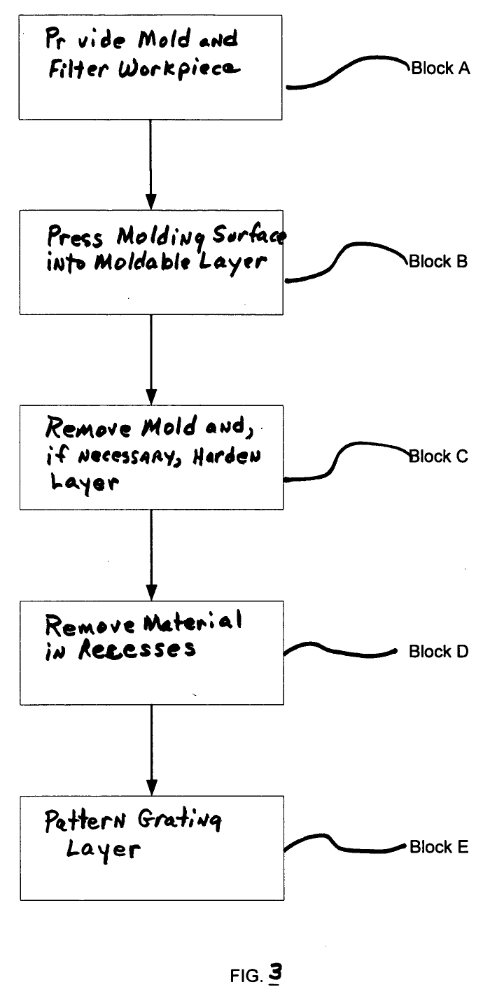

FIG. 3 is a schematic flow diagram of an improved process for fabricating SRGFs such as the one shown in FIG. 1. A preliminary step shown in block A, is to provide a mold having an appropriately patterned molding surface. Typically, for forming a grating, the patterned molding surface will comprise one or more protruding features for producing an array of recessed regions in a moldable layer. Also as a preliminary step, the unpatterned grating layer for the SRGF is provided with a moldable coating such as a thin layer of polymer resist. By “moldable” is meant that the material retains or can be hardened to retain the imprint of the protruding features of the mold. Conveniently the grating layer is adjacent the waveguide layer which, in turn, overlies a substrate. The waveguide layer should have a refractive index greater than the grating layer or the underlying substrate.

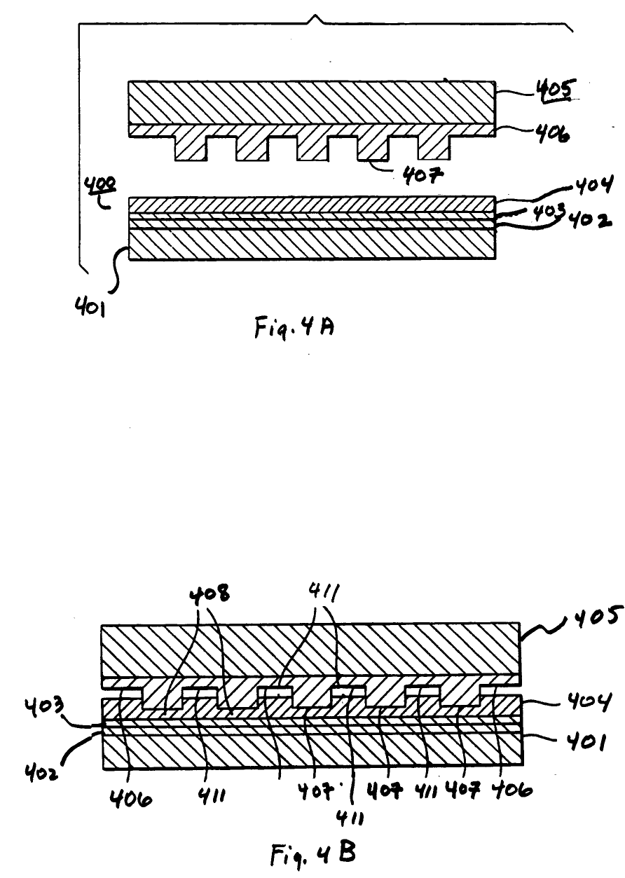

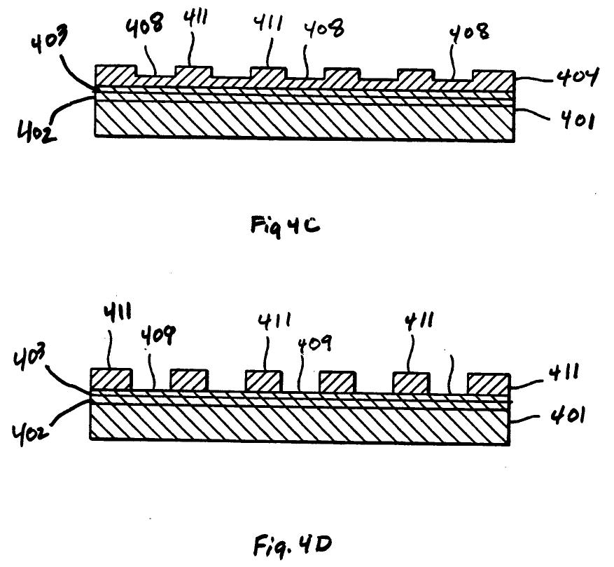

FIG. 4A is a schematic cross section showing a filter workpiece 400 comprising a substrate 401, a waveguide layer 402, an unpatterned grating layer 403 adjacent the waveguide layer and a moldable layer 404 overlying the grating layer 403. The mold 405 includes a molding surface 406 with one or more projecting features 407 for forming a periodic array. In a typical embodiment, the substrate 401 is glass, the waveguide layer 402 is silica, the grating layer 403 is silicon nitride and the moldable layer 404 is a polymer resist such as PMMA. The mold 405 can comprise fused quartz with a molding surface 406 of quartz or metal patterned to nanoscale dimensions by E beam patterning. The patterning can be designed, for example, to imprint an array of recessed holes or an array of pillars.

The next step (Block B) is to press the molding surface into the moldable layer to reduce the thickness of the moldable layer under the protruding features to produce reduced thickness regions. The pressing can be effected by a high precision mechanical press as described in U.S. Pat. No. 5,772,905 issued to Stephen Chou on Jun. 30, 1998 and U.S. Pat. No. 6,309,580 issued to Stephen Chou on Oct. 30, 2001, both of which are incorporated herein by reference. The pressing can alternatively be effected by direct fluid pressure as described in U.S. Pat. No. 6,482,742 issued to S. Chou on Nov. 19, 2002 or by electrostatic or magnetic field as described in U.S. patent application Ser. No. 10/445,578 filed by S. Chou on May 27, 2003, which '742 patent and '578 application are incorporated by reference. The details and relative advantages of these different methods of pressing are set forth in the aforementioned patents and application.

FIG. 4B shows the molding surface 406 pressed into the moldable surface layer 404. The projecting features 407 form, in the moldable layer, a corresponding pattern of reduced thickness regions 408. Recessed regions 411 of the mold do not reduce the thickness.

The third step shown in Block C of FIG. 3 is to harden the moldable thin film, if necessary, so that it retains the imprint of the mold and to remove the mold. The process for hardening depends on the material of the moldable layer. Some materials will maintain the imprint with no hardening. Others require heating and cooling, or thermal or UV curing.

FIG. 4C shows the imprinted substrate after hardening and mold removal. The moldable surface retains the pattern of reduced thickness regions 408.

The next step (Block D of FIG. 3) is to remove material from the reduced thickness regions 408 to expose the underlying grating layer. This can be conveniently accomplished using reactive ion etching. FIG. 4D illustrates the resulting structure with selected portions 409 of the grating layer exposed for further processing and the remaining portions masked by the remaining moldable surface layer.

The final step is to process the grating layer into a grating array. This can be most easily accomplished by etching away the exposed portions 409 of the grating layer, leaving an array of grating elements (13 of FIG. 1). Depending on the mold pattern used, the array can be a linear array of lines, a two-dimensional array of pillars or a two-dimensional array of holes. The lines, pillars or holes should have nanoscale lateral dimensions less than a micrometer and preferably less than about 200 nanometers. Successive grating elements should be spaced apart less than a wavelength of the light to be processed, and in a two-dimensional array for polarization independence, the periodic spacings of the array should be orthogonal. The resulting SRGF can, for example, comprise an array of circular pillars as shown in FIG. 1.

It is understood that the above-described embodiments are illustrative of only a few of the many possible specific embodiments, which can represent applications of the invention. Numerous and varied other arrangements can be made by those skilled in the art without departing from the spirit and scope of the invention.

What is claimed is:

1. A polarization independent optical filter comprising:
a planar waveguide layer;
a grating layer adjacent to said planar waveguide layer wherein said grating layer comprises a plurality of diffraction elements patterned as a two-dimensional array exhibiting periodicity in first and second orthogonal directions, each diffraction element comprising a longitudinal pillar having a maximum lateral dimension of less than 600 nanometers.

2. The polarization independent optical filter according to claim 1 wherein said waveguide layer is formed overlying a substrate layer.

3. The polarization independent optical filter of claim 1 wherein said waveguide layer and said grating layer are composed of a transparent dielectric material and the index of refraction of said waveguide layer is greater than the effective index of said grating layer.

4. The polarization independent optical filter according to claim 1 wherein the periodicity in said first and second orthogonal directions is equal.

5. The polarization independent optical filter according to claim 1 wherein said plurality of diffraction elements are circular pillars.

6. The polarization independent optical filter according to claim 1 wherein the spacing between successive diffraction elements in both orthogonal directions is less than a wavelength of the light to be filtered.

7. The polarization independent optical filter according to claim 2 wherein said substrate is composed of a transparent dielectric material having an index of refraction less than the refractive index of said waveguide layer.

8. A method of making an optical subwavelength resonant gratin filter comprising the steps of:
providing a workpiece comprising a waveguide layer, an adjacent unpatterned grating layer and a moldable layer overlying the grating layer;
providing molding surface comprising one or more projecting features patterned to form a periodic array;
pressing the molding surface against the moldable layer to produce a pattern of reduced thickness regions, in the moldable layer;
removing material from the reduced thickness regions to expose the grating layer; and
processing the exposed grating layer to form a periodic grating array.

9. The method of claim 1 wherein the molding surface is patterned to produce reduced thickness regions in the moldable layer forming an array of projecting pillars.

10. The method of claim 1 wherein the molding surface is patterned to produce reduced thickness regions in the moldable layer forming an array of recessed holes.

11. The method of claim 1 wherein the molding surface is pressed against the moldable layer by pressing with a mechanical press.

12. The method of claim 1 wherein the molding surface is pressed against the moldable layer by pressing with pressurized fluid.

13. The method of claim 1 wherein the molding surface is pressed against the moldable layer by pressing with electrostatic force.

14. The method of claim 1 wherein the molding surface is pressed against the moldable layer by pressing with magnetic force.

15. The method of claim 1 wherein the grating layer has a thickness of 200 nanometers or less.

16. The method of claim 9 wherein the pillars have a maximum lateral dimension of less than 600 nanometers.

17. The method of claim 10 wherein the holes have a maximum lateral dimension of less than 600 nanometers.

18. The method of claim 1 wherein the array is spaced apart by a periodic spacing in the range 200 nanometers to 1.2 micrometers.
